(19) United States
(12) Patent Application Publication
(10) Pub. No.: US 2005/0033981 A1
(43) Pub. Date: Feb. 10, 2005

(54) Function restricting program, installer creation program and program storage medium

(75) Inventor: Kensuke Tsurumaki, Hino (JP)

Correspondence Address: STAAS & HALSEY LLP, SUITE 700, 1201 NEW YORK AVENUE, N.W., WASHINGTON, DC, 20005, US

(73) Assignee: FFC LIMITED, Tokyo (JP)

(21) Appl. No.: 10/806,214

(22) Filed: Mar. 23, 2004

(30) Foreign Application Priority Data
Aug. 4, 2003 (JP) 2003-286094

(51) Int. Cl. H04L 9/00

(52) U.S. Cl. 713/200

(57) ABSTRACT

A function restricting program capable of effecting minute security setting is disclosed. Based a security policy containing inhibited process designating information defined as information for designating some processes of which executions are not permitted with respect to one or more caption character strings, the program makes the computer operate as a device that does not execute respective processes of which executions are not permitted by inhibited process designating information contained in security policy information with respect to a caption character string coincident with a title character string of the function restricting target window in a case where the function restricting target window of which the title character string is coincident with any one of caption character strings in the security policy information, is displayed on the display device.

### BACKGROUND OF THE INVENTION

1. Field of the Invention

The present invention relates to a function restricting program for preventing information from being leaked, etc., an installer creation program for creating an installer for installing the function restricting program into a computer, a program storage medium stored with the function restricting program, and a program storage medium stored with the installer creation program.

2. Description of the Related Art

As known well, jobs have been conducted by utilizing computers in offices, factories, etc. (which will hereinafter be generically referred to as offices, etc.) over the recent years. Pieces of information used for the jobs, however, contain information that should be prevented from being printed and copied to mediums by unauthorized parties (that should be prevented from being leaked to the outside).

A scheme of inhibiting the information from being printed and copied to the mediums by the unauthorized parties can be actualized by making each computer operate as a device requesting a user to input a user name and a password when starting the use of the computer (or when printing and copying the information to the medium). As a matter of fact, there exist offices, etc. where the leakage of the information is prevented by adopting the password system.

The actualization of enabling the group of existing computers to prevent the information leakage by utilizing the password system, must involve a variety of operations (such as replacing the preinstalled OS and applications, and changing the settings) for the respective computers. Namely, the information leakage preventing scheme based on the password system takes a large cost for carrying out this scheme. Further, the information leakage preventing scheme based on the password system involves a change in operation procedures of the computer (wherein the password, etc. must be inputted when starting the use thereof and when printing).

Such being the case, there has been developed a program (refer to, e.g., Japanese Patent Application Laid-open Publication No.2002-149297) capable of invalidating each menu item specifying a designated application by previously designating the application (web Browser, etc.) and menu items related to printing and saving) to be invalidated, i.e., by performing a so-called message hook.

The use of this program enables each computer to operate as a device operable in the same procedures as conducted so far but capable of preventing the unauthorized parties from printing and copying the information to the mediums. That is, it is feasible to actualize an environment capable of preventing the information leakage by using this program without causing any problems arising when adopting the password system.

In this program, however, the security setting (such as designating which menu item is invalidated) can not be done except on an application-by-application basis. Therefore, on the occasion of utilizing this problem, there arises a problem in which it is impossible to set printable one piece of information of two pieces of information utilizing the same application for browsing and the other piece of information unprintable.

### SUMMARY OF THE INVENTION

Under such circumstances, it is a first object of the present invention to provide a function restricting program capable of performing more minute security setting.

It is a second object of the present invention to provide an installer creation program capable facilitating an operation of installing the function restricting program into a plurality of computers.

To accomplish the first object, according to the present invention, a function restricting program executed on a computer including an input device and a display device, is created(written) so that it makes, on the basis of security policy information containing inhibited process designating information defined as information for designating some processes of which executions are not permitted with respect to one or more caption character strings, the computer operate as a device that does not execute respective processes of which executions are not permitted by inhibited process designating information contained in the security policy information with respect to a caption character string coincident with a title character string of the function restricting target window in a case where the function restricting target window defined as a window of which the title character string is coincident with any one of caption character strings in the security policy information, is displayed on the display device.

The use of this function restricting program enables the security setting to be done for every caption character string (title character string), whereby the more minute security setting than by the prior art can be performed such as setting printable one piece of information of two pieces of information utilizing the same application for browsing and the other piece of information unprintable.

To accomplish the second object, according to the present invention, there is created an installer creation program making a computer including an input device and a display device, operate as a device comprising security policy information creating means for creating security policy information containing inhibited process designating information defined as information for designating some processes of which executions are not permitted with respect to one or more caption character strings on the basis of information inputted to the input device, and installer creating means for creating an installer defined as a program by which, upon an execution of this program, a computer is installed with the security policy information created by the security policy information creating means and with the function restricting program of the present invention.

The use of the present installer creation program eliminates a necessity of performing an operation of setting the security policy information on the computer installed with the function restricting program. Hence, the use of the installer creation program of the present invention facilitates an operation of installing the function restricting program into a plurality of computers.

### BRIEF DESCRIPTION OF THE DRAWINGS

These and other objects and advantages of the present invention will become clear from the following description with reference to the accompanying drawings, wherein:

FIG. 1 is an explanatory diagram of a system in which a function restricting program according to one embodiment of the present invention is utilized;

FIG. 2 is an explanatory diagram of a security policy file utilized by the function restricting program;

FIG. 3 is an explanatory diagram of a caption character string registration dialog box displayed when creating and editing the security policy file;

FIG. 4 is an explanatory diagram of a security policy setting dialog box displayed when creating and editing the security policy file; and

FIG. 5 is a flowchart showing operation procedures of the function restricting program.

### DETAILED DESCRIPTION OF THE PREFERRED EMBODIMENTS

A best mode for embodying the present invention will hereinafter be described in detail with reference to the drawings.

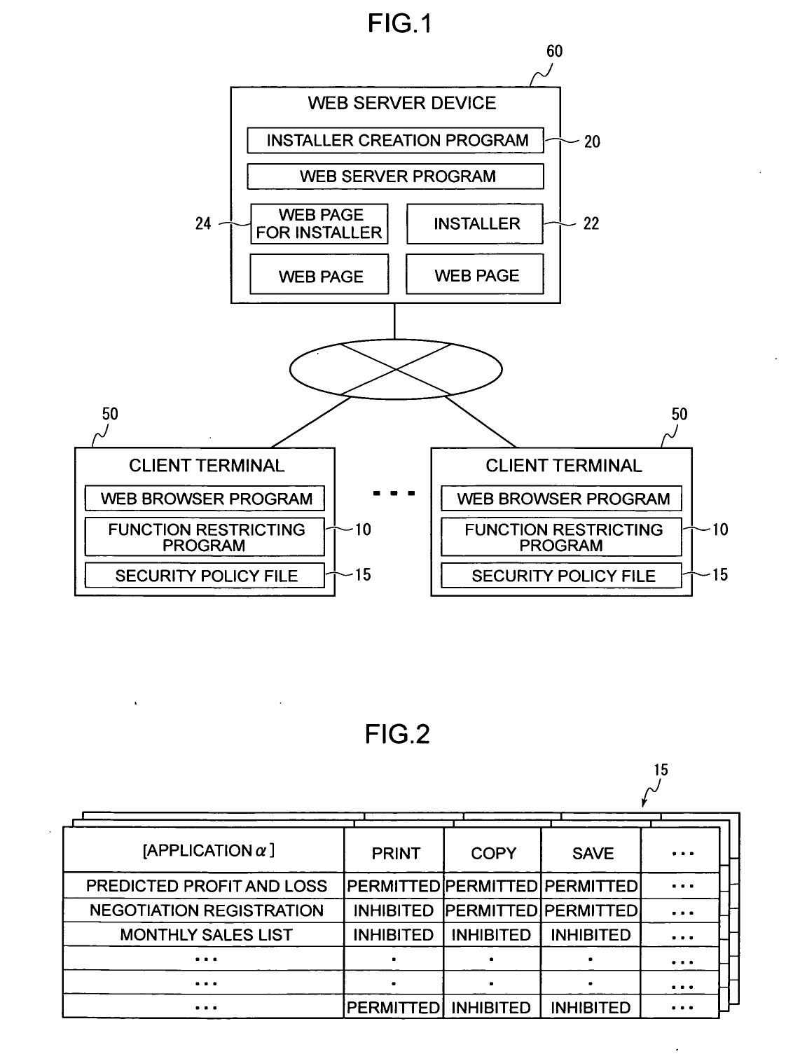

As schematically illustrated in FIG. 1, a function restricting program 10 according to one embodiment of the present invention is a program created on the assumption that this program is executed on respective client terminals 50 in a system (which will hereinafter be termed a business-oriented network system) including a web server device 60 and a plurality of client terminals 50 provided with various categories of web pages from the web server device 60.

The web server device 60 in the business-oriented network system utilizing this function restricting program 10, is normally preinstalled with an installer creation program 20 defined as a program prepared for easily installing the function restricting program 10 (and a security policy file 15) with respect to the client terminals 50.

The installer creation program 20 has, though its detailed explanation is omitted herein, a function (a) of creating and editing the security policy file 15 in accordance with an instruction given from an operator (who is an administrator of the business-oriented network system), a function (b) of creating an installer 22 for installing the thus created-and-edited security policy file 15 together with the function restricting program 10 into a computer (the client terminal 50), a function (c) of generating a web page 24 for the installer, through which the created installer 22 can be downloaded, and so forth.

The security policy file 15 connoted herein has contents (a file-formatted database) as schematically shown in FIG. 2, to which the function restriction program 10 refers when in its operation. Namely, the security policy file 15 is a file that retails a given number of tuples (records corresponding to a plurality of applications) each consisting of a caption character string and pieces of information (which will hereinafter be termed “inhibited process designating information”) designating which process among a variety of processes is inhibited from being executed.

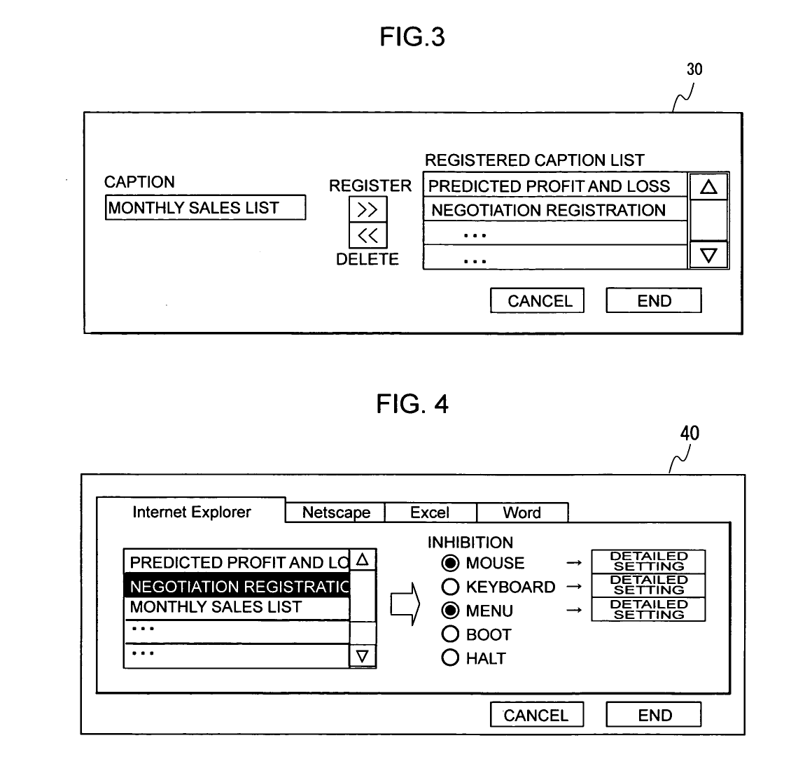

Note that when creating he security policy file 15 by utilizing the installer creation program 20, a caption character string registration dialog box 30 as shown in FIG. 3 and a security policy setting dialog box 40 as shown in FIG. 4 are displayed on the display of the web server device 60.

Namely, the actual security policy file 15 retains a given number of tuples each consisting of the caption character string and the pieces of inhibited process designating information designating which operation by a user is invalidated (refer to the caption in the security policy setting dialog box 40 in FIG. 4) with respect to each of web Browsers such as Microsoft Internet Explorer, Netscape Navigator, Microsoft Excel and Microsoft word (Microsoft Internet Explorer, Microsoft Excel and Microsoft word are trademarks of Microsoft corporation in U.S.A., and Netscape Navigator is a trademarks of Netscape communication corporation in U.S.A. and other countries).

Further, the actual security policy file 15 is stored with the inhibited process designating information containing various pieces of information such as information indicating whether a screen copy is invalidated or not (“Print screen” key is invalidated or not), information indicating whether each menu item such as “saving with a name” is invalidated or not, information indicating whether a right click is inhibited or not, and so forth.

On the other hand, the present function restricting program 10 has, as the installer creation program 20 has, the function of creating and editing the security policy file 15. The function restricting program 10 involves preparing a CD-ROM for installing the function restricting program 10 into the client device (terminal) 50. In the case of installing the function restricting program 10 into the client device 50 from the CD-ROM, an operation of creating the security policy file 15 by utilizing the aforementioned functions included in the function restricting program 10, is performed by the administrator.

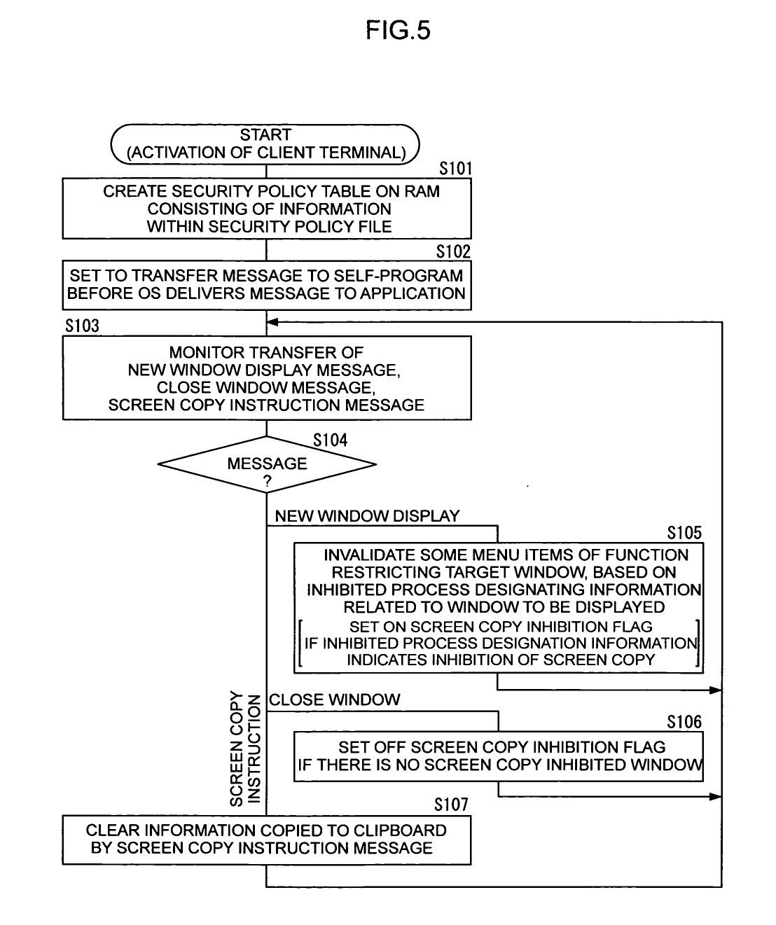

The function restricting program 10, when booted (when an OS on the client terminal 50 is booted), starts processing in procedures shown in FIG. 5. Incidentally, in the following discussion, the application in which to set the information consisting of the caption character string and the inhibited process designating information in the security policy file 15, will be termed a function restricting target (object) application.

Namely, the function restricting program 10 executes, to begin with, a process of creating, on a RAM, a security policy table structured of pieces of information within the security policy file 15 (step S101). In short, the function restricting program 10 executes the process for setting the information stored in the security policy file 15 in a usable state without accessing a HDD.

Thereafter, the function restriction program 10 executes in step S302 a process (for performing a so-called global hook) for the OS (windows XP, etc.: windows XP is a trademark of Microsoft corporation, in U.S.A.) to transfer a message to the self-program before delivering the message to the application.

Subsequently, the function restricting program 10 starts a process (step S103) of monitoring a transfer, from the OS, of a message (which will hereinafter be called a new window display message) through which a window (which will hereinafter be called a function restricting target window) containing a tile character string construed coincident with any one of the caption character strings in the security policy table, is to be displayed on the display by the function restricting target application, and a message (which will hereinafter be called a window closed message) through which the function restricting target window is closed. Note that if a screen copy inhibition flag (of which details will be explained later on; an initial value is “OFF”) is set ON, in step S103, the function restricting program 10 monitors a transfer, from the OS, of a message (which will be called a screen copy instruction message) through which image data on the screen displayed on the display are copied to a clipboard.

Then, if the new window display message is transferred (step S103; new window display), the function restricting program 10 executes a process (step S105) for invalidating each menu item and a keyboard operation for instructing the function restricting target application for displaying the function restricting target window to execute each process that should be inhibited by the inhibited process designating information associated with (linked to) the function restricting target window. Further, the function restricting program 10, if the inhibited process designating information associated with the function restricting target window is an inhibition of the screen copy, executes also a process of setting the screen copy inhibition flag in an “ON” status in step 105. It is to be noted that the inhibited process designating information associated with the function restricting target window, is the inhibited process designating information stored in the security policy table (the security policy file 15) in such a way that the function restricting target application for displaying the function restricting target window is associated with the caption character string construed coincident with the title character string of the function restricting target window.

The function restricting program, which has finished the process in step S105, restarts the process in step S103.

The function restricting program 10, when the window closed message is transferred (step S103; window closed, executes a process (step S106) for setting the screen copy inhibition flag in an “OFF” status, unless the function restricting target window left after the function restricting target window has been closed by the window closed message contains any elements indicating the inhibition of the screen copy. Thereafter, the function restricting program 100 again starts the process in step S102. The function restricting program 10, when the screen copy instruction message is transferred (step S103; instruction of screen copy), executes a process (step S107) for clearing the information copied to the clipboard by the screen copy instruction message, and thereafter restarts the process in step S103.

As discussed above, the function restricting program 10 in the present embodiment is capable of designating the security level (a category of the process for inhibiting the execution) with the title character string. Therefore, the use of this function restricting program 10 enables the security setting that is as minute as setting printable one piece of information of two pieces of information utilizing the same application for browsing and the other piece of information unprintable.

The function restricting program 10 does not judge, based on the process inhibition designating information set for the active function restricting target window, whether the screen copy is inhibited or not (the screen copy is inhibited in a case where there exists even one function restricting target window with the screen copy inhibited). Accordingly, the client terminal 50 preinstalled with the function restricting program 10 functions as a device (unable to extract the information about the function restricting target window with the screen copy inhibited) unable to perform the screen copy even by simultaneously displaying, on the display, the function restricting target window with the screen copy inhibited and the function restricting target window with the screen copy uninhibited.

<Modified Mode>

The function restricting program 10 described above can be modified in a variety of forms. For instance, the function restricting program 10 may be modified so that only the window of which the title character string is coincident with the caption character string in the security policy file 15 (the security policy table), is dealt with as the function restricting target window. The function restricting program 10 may also be modified so that the window of which the title character string is similar to the caption character string (which is a window having the same title character string as the caption character string if, for example, half-size characters are changed into full-size characters), is also dealt with as the function restricting target window. The function restricting program 10 may also be modified so as to invalidate the screen copy only when the function restricting target window with the screen copy inhibited is actually displayed (so as no to invalidate the screen copy in a case where the function restricting target window with the screen copy inhibited is minimized and a case where all of this window is hidden by other window).

Moreover, it is a matter of course that the categories of the applications as the function restricting targets may be set different from those described above, and that the dialog boxes displayed when creating and modifying the security policy file 15 may be set different from those described above.

1. A function restricting program executed on a computer including an input device and a display device,
said program making, on the basis of security policy information containing inhibited process designating information defined as information for designating some processes of which executions are not permitted with respect to one or more caption character strings, said computer operate as a device that does not execute respective processes of which executions are not permitted by inhibited process designating information contained in the security policy information with respect to a caption character string coincident with a title character string of the function restricting target window in a case where the function restricting target window defined as a window of which the title character string is coincident with any one of caption character strings in the security policy information, is displayed on said display device.

2. A function restricting program according to claim 1, wherein a window of which a title character string contains any one of the caption character strings in the security policy information, is also dealt with as the function restricting target window.

3. A function restricting program according to claim 1, including a function of making said computer, in a case where a plurality of function restricting target windows are displayed on said display device, operate as a device that does not execute a process of which an execution is not permitted by any one piece of inhibited process designating information, in the security policy information, associated with title character strings of these function restricting target windows.

4. An installer creation program making a computer including an input device and a display device, operate as a device comprising:
security policy information creating means for creating security policy information containing inhibited process designating information defined as information for designating some processes of which executions are not permitted with respect to one or more caption character strings on the basis of information inputted to said input device; and
installer creating means for creating an installer defined as a program by which, upon an execution of this program, a computer is installed with the security policy information created by said security policy information creating means and with said function restricting program according to claim 1.

5. A program storage medium stored with a function restricting program executed on a computer including an input device and a display device,
said function restricting program making, on the basis of security policy information containing inhibited process designating information defined as information for designating some processes of which executions are not permitted with respect to one or more caption character strings, said computer operate as a device that does not execute respective processes of which executions are not permitted by inhibited process designating information contained in the security policy information with respect to a caption character string coincident with a title character string of the function restricting target window in a case where the function restricting target window defined as a window of which the title character string is coincident with any one of caption character strings in the security policy information, is displayed on said display device.

6. A program storage medium stored with a function restricting program according to claim 5, wherein said function restricting program deals with a window of which a title character string contains any one of the caption character strings in the security policy information, also as the function restricting target window.

7. A program storage medium stored with a function restricting program according to claim 5, wherein said function restricting program includes a function of making said computer, in a case where a plurality of function restricting target windows are displayed on said display device, operate as a device that does not execute a process of which an execution is not permitted by any one piece of inhibited process designating information, in the security policy information, associated with title character strings of these function restricting target windows.

8. A storage medium stored with an installer creation program making a computer including an input device and a display device, operate as a device comprising:
security policy information creating means for creating security policy information containing inhibited process designating information defined as information for designating some processes of which executions are not permitted with respect to one or more caption character strings on the basis of information inputted to said input device; and
installer creating means for creating an installer defined as a program by which, upon an execution of this program, a computer is installed with the security policy information created by said security policy information creating means and with said function restricting program according to claim 1.
